(19) United States
(12) Patent Application Publication
(10) Pub. No.: US 2021/0097184 A1
(43) Pub. Date: Apr. 1, 2021

(54) SECURE BUFFER FOR BOOTLOADER

(71) Applicants: ADVANCED MICRO DEVICES, INC., Santa Clara, CA (US); ATI TECHNOLOGIES ULC, Markham (CA)

(72) Inventors: Murali RAO, Austin, TX (US); Clarence IP, Markham (CA); Joseph SCANLON, Santa Clara, CA (US); Mihir S. DOCTOR, Santa Clara, CA (US); Norman STEWART, Markham (CA); Guhan KRISHNAN, Boxborough, MA (US)

(21) Appl. No.: 16/586,226

(22) Filed: Sep. 27, 2019

(51) Int. Cl. G06F 21/57; G06F 21/51; G06F 9/4401; G06F 13/16

(52) U.S. Cl. CPC G06F 21/575; G06F 21/51; G06F 2221/033; G06F 13/1668; G06F 9/4403

(57) ABSTRACT

A processing system isolates at a physically or logically separate memory region of a processing unit boot code that is received from an external boot source for programming a boot memory of the processing unit until after the boot code is validated to protect against buffer overruns that could compromise the processing system. The processing unit includes a secure buffer region of memory that is physically or logically isolated from the remainder of the processing unit for receiving boot code from an external boot source such as a personal computer (PC) such that any buffer overruns at the secure buffer simply overwrite data stored at the secure buffer, and do not affect data or instructions that are executing at the processing unit.

### BACKGROUND

Initialization of a processing system typically requires initializing a central processing unit (CPU), initializing system memory which is typically provided external to the CPU, security provisioning of the system, loading an operating system into the system memory from an external mass storage device, and executing user applications. The process of initializing the various hardware components of the processing system, such as the system memory, and the execution of the instructions contained in the system memory for initializing the higher system levels, which is also be referred to as bootstrapping or bootloading, can expose the processing system to vulnerabilities in the case of a malicious attack.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system incorporating a secure region of memory for storing boot code received from an external boot media device in accordance with some embodiments.

FIG. 2 is a block diagram of an example of the processing system of FIG. 1 storing batches of boot code at a secure memory region pending validation in accordance with some embodiments.

FIG. 3 is a flow diagram illustrating a method for isolating batches of boot code at a secure memory region pending validation in accordance with some embodiments.

### DETAILED DESCRIPTION

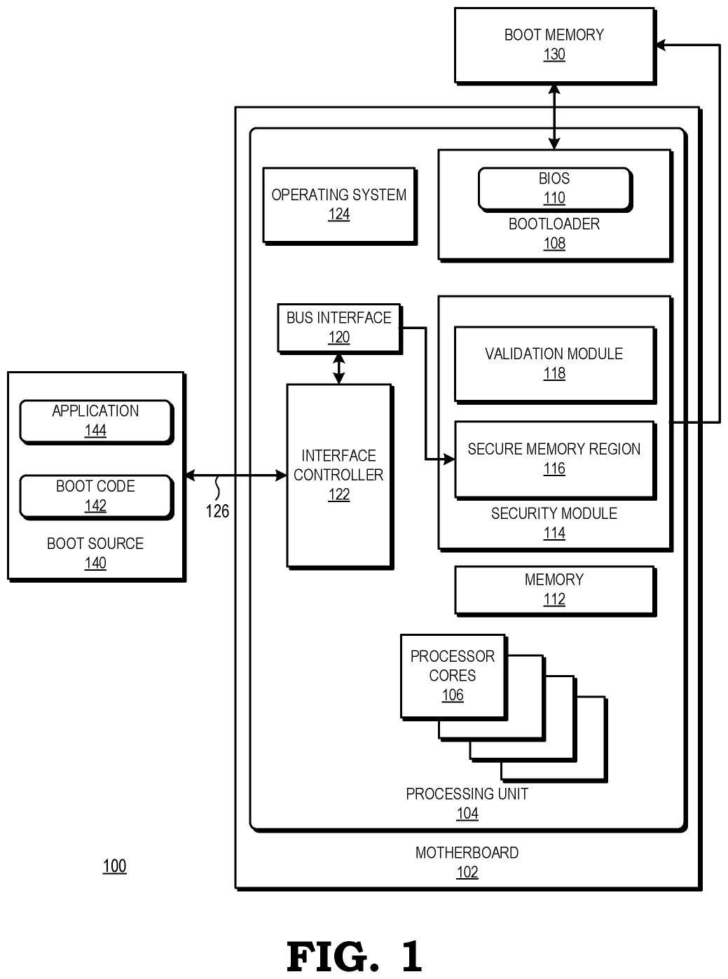

FIGS. 1-3 illustrate example techniques for isolating at a physically or logically separate memory region of a processing unit of a processing system boot code received from an external boot source for programming a boot memory until after the boot code is validated to protect against buffer overruns that could compromise the processing system. Receiving boot code from an external boot source potentially exposes the processing system to malicious attacks. For example, when boot code is received into a conventional buffer associated with a bootloader, a malicious attacker can overrun the buffer and corrupt data or instructions that are executing at a processor of the processing unit. To protect the processing unit from buffer overruns, the processing unit includes a secure region of memory for receiving boot code from an external boot source such as a personal computer (PC). The secure region of memory is an independent memory region that is physically or logically isolated from the remainder of the processing unit. Thus, any buffer overruns at the secure buffer simply overwrite data stored at the secure buffer, and do not affect data or instructions that are executing at the processor.

During a first stage of a boot process, a bootloader of the processing unit executes code out of a boot memory connected to the processing unit. The bootloader bootstraps the hardware of the processing unit and reads from the boot memory that in some embodiments is external to the processing unit to obtain software and hardware necessary for the next stage of the boot process, after which the processor completes the boot process. However, if the bootloader detects that the contents of the boot memory are invalid or blank, or if the processing unit receives a request to enter a mode to program the boot memory, the processing unit enables a bus interface to access the physically or logically separate secure memory region of the processing unit. The processing unit then initializes a peripheral interface controller of the processing unit to open a communication channel, allowing an external boot source such as a PC to connect to the processing unit via a suitable interface protocol and connection, such as, e.g., a USB interface and USB cable, a RS-232 interface and RS-232 serial cable, or an 802.11x wireless interface.

In response to the communication channel opening, the external boot source transfers boot code to the secure memory region of the processing unit via the USB. Once the boot code has been transferred to the secure memory region, the secure memory region stores the boot code while the processing unit validates the boot code by performing a validation protocol. In some embodiments, the validation protocol includes one or more validation methods such as, for example, performing a checksum (which in some embodiments is cryptographically-based), checking the source of the code, checking for known malicious code or code content, checking that the overall code size (including the sum of any individual batches as described below) does not exceed the capacity of the boot memory, or performing cryptographic authentication such as a secure hash. In response to the processing unit validating the boot code, the processing unit programs the boot code onto the boot memory.

In some embodiments, the amount of boot code exceeds the capacity of the secure memory region. If the amount of boot code exceeds the storage capacity of the secure memory region, the external boot source transfers the boot code in batches to the processing unit. For example, the external boot source transfers a first batch of boot code to the secure memory region, and the processing unit validates the first batch and transfers the first batch to the boot memory. In response to transferring the first batch to the boot memory, the external boot source transfers a second batch of boot code to the secure memory region, and the processing unit validates the second batch and transfers the second batch to the boot memory. The process of transferring a next batch of boot code to the secure memory region, validating the next batch, and transferring the next batch to the boot memory continues until all batches of boot code have been validated and transferred to the boot memory. Once all batches of boot code have been validated and transferred to the boot memory, the processing unit verifies a signature of the boot code (e.g., by calculating a signature for each of the batches and verifying that a sum of signatures for each of the batches matches an expected signature) and then boots the processor core(s) using the boot code.

FIG. 1 illustrates a processing system 100 having a processing unit 104 that incorporates a secure memory region 116 for storing boot code 142 received from an external boot source 140 in accordance with some embodiments. In some embodiments, the processing system 100 includes a boot memory 130 that is external to the processing unit 104. In some embodiments, the boot memory 130 is a flash memory device. The processing unit 104 is packaged with a motherboard 102 that provides power and support to the processing unit 104, one or more processor cores 106, a basic input output system (BIOS) 110, a bootloader 108, a memory 112, a security module 114, a bus interface 120, an interface controller 122, and an operating system (OS) 124. Components of the processing system 100 are be implemented as hardware, firmware, software, or any combination thereof In some embodiments, the processing system 100 includes one or more software, hardware, and firmware components in addition to or different from those shown in FIG. 1.

In some embodiments, the processing unit 104 is an accelerated processing unit and the one or more processor cores 106 include at least one central processing unit (CPU) and at least one graphic processing unit (GPU). The processing system 100 is generally configured to execute sets of instructions (e.g., computer programs) to carry out specified tasks for an electronic device. Examples of such tasks include controlling aspects of the operation of the electronic device, displaying information to a user to provide a specified user experience, communicating with other electronic devices, and the like. Accordingly, in different embodiments the processing system 100 is employed in one of a number of types of electronic device, such as a desktop computer, laptop computer, server, game console, tablet, smartphone, and the like.

In some embodiments, each CPU processor core 106 includes one or more instruction pipelines to fetch instructions, decode the instructions into corresponding operations, dispatch the operations to one or more execution units, execute the operations, and retire the operations. In the course of executing instructions, the CPU processor cores 106 generate graphics operations and other operations associated with the visual display of information. Based on these operations, the CPU processor cores 106 provide commands and data to a GPU processor core 106.

The GPU processor cores 106 are generally configured to receive the commands and data associated with graphics and other display operations from the plurality of CPU processor cores 106. Based on the received commands, the GPU processor cores 106 execute operations to generate frames for display. Examples of operations include vector operations, drawing operations, and the like. The number of processor cores 106 that are implemented in the processing unit 104 is a matter of design choice. Each of the processor cores 106 includes one or more processing elements such as scalar and/or vector floating-point units, arithmetic and logic units (ALUs) and the like. In various embodiments, the processor cores 106 also includes special purpose processing units (not shown), such as inverse-square root units and sine/cosine units.

The CPU and GPU processor cores 106 are coupled to a memory 112. The CPU and GPU processor cores 106 execute instructions stored in the form of one or more software programs and store information in the memory 112 such as the results of the executed instructions. In various embodiments, the memory 112 stores processing logic instructions, constant values, variable values during execution of portions of applications or other processing logic, or other desired information. During execution, applications, operating system functions, processing logic commands, and system software reside in memory 112. Control logic commands that are fundamental to the operating system 124 generally reside in the memory 112 during execution. In some embodiments, other software commands (e.g., a device driver) also reside in memory 112 during execution of the processing unit 104. For example, the memory 112 stores a plurality of previously-generated images (not shown) that it receives from the GPU processor cores 106. In some embodiments, the memory 112 is implemented as a dynamic random access memory (DRAM), and in some embodiments, the memory 112 is implemented using other types of memory including static random access memory (SRAM), non-volatile RAM, and the like. Some embodiments of the processing system 100 include an input/output (I/O) engine (not shown) for handling input or output operations associated with a display (not shown), as well as other elements of the processing system 100 such as keyboards, mice, printers, external disks, and the like.

The bootloader 108 performs core initialization of the hardware of the processing unit 104 and loads the operating system 124. The bootloader 108 then hands control to the operating system (OS) 124, which initializes itself and configures the system hardware by, for example, setting up memory management, setting timers and interrupts, and loading device drivers. In some embodiments the bootloader includes a Basic Input/Output System (BIOS) 110 and a hardware configuration (not shown) indicating the hardware configuration of processing unit 104 and is connected to a boot memory 130. In some embodiments, the boot memory 130 is implemented as a read-only memory (ROM) that stores boot code for execution during a boot process that is initiated upon a power-on reset. Booting refers to any of a variety of initialization specifications or processes, BIOS, extensible firmware interface (EFI), unified EFI (UEFI), and the like. In some embodiments, the hardware configuration includes a start-up service such as an Advanced Configuration and Power Interface (ACPI) framework. The hardware configuration provides hardware registers to the components powered by the motherboard 102 to enable power management and device operation without directly calling each component natively such as by a hardware address. The hardware configuration serves as an interface layer between the BIOS 110 and the operating system 124 for the processor cores 106.

In the event the boot memory 130 does not store valid boot code, the processing unit 104 also enables the external boot source 140 to load boot code 142 over a suitable peripheral interface 126 such as, e.g., a USB interface. The external boot source 140 includes boot code 142 and one or more applications 144. In some embodiments, external boot source 140 is a personal computer or other computing device. The external boot source 140 is configured to program the boot memory 130 for bootloading the processing unit 104, via the suitable peripheral interface 126 of the processing unit 104.

To prevent buffer overruns in the event of a malicious attack when the external boot source 140 programs the boot memory 130 via the suitable peripheral interface 126 of the processing unit 104, the processing unit 104 includes a security module 114. The security module 114 includes a microcontroller or other processor responsible for creating, monitoring and maintaining the security environment of the processing system 100, including managing the boot process to ensure that the components of the processing system 100 boot up with authenticated boot code. The security module 114 includes a secure memory region 116 and a validation module 118. The validation module 118 is implemented as hard-coded logic, programmable logic, software executed by a processor, or a combination thereof. The secure memory region 116 is used as a secure buffer and is implemented as a region of memory that is physically separate and isolated from other regions of memory, such as the memory 112, of the processing unit 104. Thus, in some embodiments, the secure memory region 116 is accessible only via a bus interface 120 that exclusively services the secure memory region 116. In some embodiments, the secure memory region 116 is implemented as a portion of a larger memory such as a static random access memory (SRAM) associated with a processor core 106 of the processing unit 104. The physical isolation of the secure memory region 116 ensures that any data overruns of the secure memory region 116 do not spill over to affect code executing at the one or more processor cores 106, but instead merely corrupt data stored at the secure memory region 116.

In operation, during a bootstrap process, such as at a power-on reset or other boot initialization event, power is supplied to the motherboard 102. When the motherboard 102 first receives power, the bootloader 108 is activated and completes its setup, initialization, and self-tests using a power-on self-test (POST). The BIOS 110 then uses information obtained during firmware initialization to create or update tables of the hardware configuration with various platform and device configurations including power interface data.

During the boot process, the BIOS 110 identifies all available storage devices of the processor cores 106 for potential boot devices that have an operating system for the processor cores 106. The BIOS 110 uses a boot order specified in a persistent storage available to the motherboard 102. On some motherboards, the persistent storage is in a separate chip. In many instances, the BIOS persistent storage is integrated with a real-time clock (RTC) or with an integrated circuit (IC) on the motherboard 102 that is responsible for a hard drive controller, an I/O controller, and integrated components. In some embodiments, the BIOS persistent storage is provided with its own power source in the form of a battery which allows the BIOS persistent storage to maintain the boot order even if the motherboard 102 of the processing unit 104 loses primary power.

The bootloader 108 includes executable code that loads the OS 124 into the memory 112 and starts the OS 124. At this point, the BIOS 110 stops controlling the motherboard 102 and the processing system 100. The bootloader 108 loads and executes the various components of the OS 124 into the memory 112 and communicates the hardware configuration to the OS 124. The bootloader 108 also accesses software and firmware necessary for the next stage of the bootstrapping process from the boot memory 130. During its initialization, the OS 124 starts and initializes a kernel (not shown) to allow the kernel to provide tasks in the form of processor instructions to the processor cores 106. The kernel manages execution of processes on the processor cores 106.

If the processing unit 104 detects that the contents of the boot memory 130 are invalid or blank, or if the processing unit 104 receives a request from the external boot source 140 to enter a programming mode, the processing unit 104 enables the bus interface 120 to access the secure memory region 116 and initializes the interface controller 122 to open communications via the peripheral interface 126 with the external boot source 140.

The external boot source 140 transfers boot code 142 to the secure memory region 116 via the bus interface 120. The validation module 118 validates the boot code 142 stored at the secure memory region 116 to verify data integrity by, for example, performing a checksum. If the checksum validates the integrity of the boot code 142, the security module 114 releases the boot code 142 from the secure memory region 116 by allowing the one or more processor cores 106 to access the boot code 142 and program the boot code 142 onto the boot memory 130. Once the boot code 142 has been programmed onto the boot memory 130, the validation module 118 performs an additional verification of the boot code 142 to authenticate the boot code 142 by, for example, verifying a signature of the boot code 142 prior to booting from the boot code 142.

In some embodiments, the amount of boot code 142 exceeds the storage capacity of the secure memory region 116. If the amount of boot code 142 is greater than the amount of data that can be stored at the secure memory region 116, the external boot source 140 transfers the boot code 142 in two or more batches. In some embodiments, each batch of boot code 142 is sized to fit in the secure memory region 116. Once the first batch of boot code 142 is validated and programmed onto the boot memory 130, the secure memory region 116 is ready to receive the next batch of boot code 142. Each batch of boot code 142 is transferred to the secure memory region 116, validated by the validation module 118, and programmed onto the boot memory 130, making room for the next batch of boot code 142. Once all batches of the boot code 142 have been validated and programmed onto the boot memory 130, the validation module 118 authenticates the boot code 142 prior to booting.

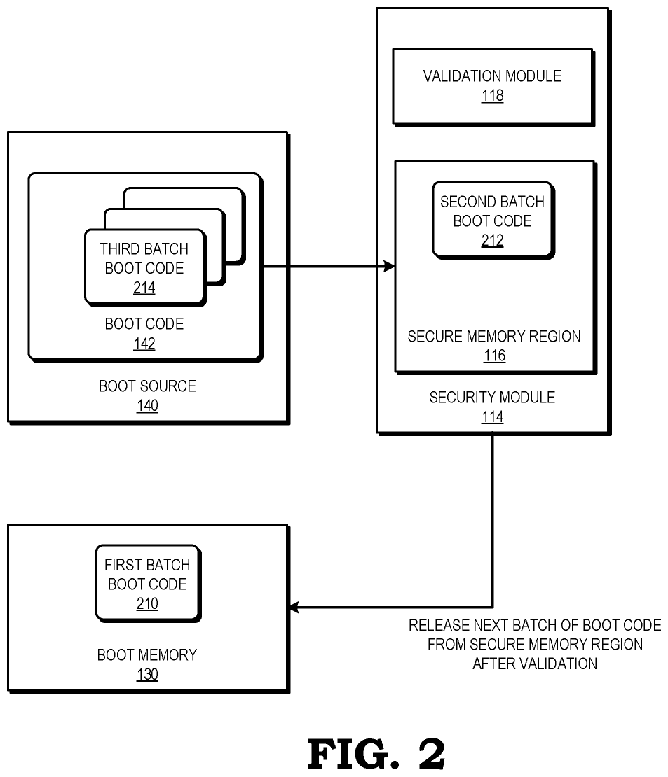

FIG. 2 is a block diagram of an example of the processing system 100 of FIG. 1 storing batches of boot code at a secure memory region 116 pending validation in accordance with some embodiments. The external boot source 140 stores boot code 142 that has been divided into a plurality of batches. In the illustrated example, a first batch of boot code 210 has already been transferred to the secure memory region 116 of the processing unit 104, its checksum validated by the validation module 118, and transferred to the boot memory 130. A second batch of boot code 212 is stored in isolation at the secure memory region 116 pending validation of its checksum by the validation module 118. Once the second batch of boot code 212 is validated by the validation module 118, the second batch of boot code will be released to the boot memory 130. A third batch of boot code 214, as well as subsequent batches of boot code, are stored at the external boot source 140 awaiting transfer to the secure memory region 116. Once the second batch of boot code is released to the boot memory 130, the third batch of boot code 214 will be transferred to the secure memory region 116.

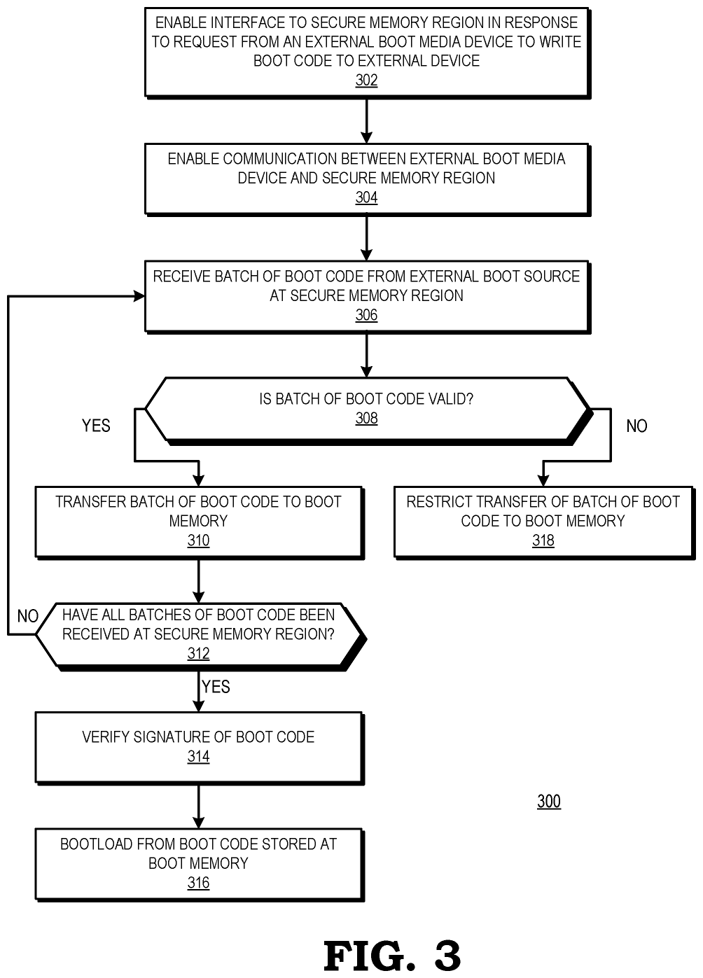

FIG. 3 is a flow diagram illustrating a method 300 for isolating batches of boot code at a secure memory region pending validation in accordance with some embodiments. The method 300 is implemented in some embodiments of the processing system 100 shown in FIGS. 1 and 2. At block 302, the processing unit 104 enables the bus interface 120 to the secure memory region 116 in response to receiving a request from an external boot source 140 connected to the processing unit 104 via a suitable peripheral interface 126 to write boot code 142 to the boot memory 130. At block 304, the processing unit 104 enables communication between the external boot source 140 and the secure memory region 116.

At block 306, the processing unit 104 receives a batch of boot code 210 from the external boot source 140 at the secure memory region 116. At block 308, the validation module 118 of the processing unit 104 determines whether the batch of boot code 210 is valid. In some embodiments, the validation module 118 validates the batch of boot code 210 using a validation protocol such as calculating a cryptographic hash, or other protocol to determine whether the boot code is valid. If, at block 308, the validation module 118 determines that the batch of boot code 210 is not valid, the method flow continues to block 318. At block 318, the security module 114 restricts transfer of the block of boot code to the boot memory 130.

If, at block 308, the validation module 118 determines that the batch of boot code 210 is valid, the method flow continues to block 310. At block 310, the processing unit 104 transfers the batch of boot code 210 to the boot memory 130. At block 312, the processing unit 104 determines whether all batches of boot code have been received at the secure memory region 116. In some embodiments, the external boot source 140 communicates to the processing unit 104 the total number of batches of boot code to be transferred when the external boot source 140 requests to write boot code to the boot memory 130 at block 302. If, at block 312, the processing unit 104 determines that all batches of boot code to be written to the boot memory 130 have not been received at the secure memory region 116, the method flow continues back to block 306, at which the external boot source 140 transfers the next batch of boot code to the secure memory region 116.

If, at block 312, the processing unit 104 determines that all batches of boot code to be written to the boot memory 130 have been received at the secure memory region 116, the method flow continues to block 314. At block 314, the validation module 118 verifies a signature of the boot code that has been transferred to the boot memory 130. At block 316, after the boot code has been verified, the processing unit 104 bootloads from the boot memory 130 using the boot code.

A computer readable storage medium includes any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium is embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above are implemented by one or more processors of a processing system executing software. The software includes one or more sets of executable instructions stored or otherwise tangibly embodied on a non-transitory computer readable storage medium. The software includes the instructions and certain data that, when executed by the one or more processors, manipulate the one or more processors to perform one or more aspects of the techniques described above. The non-transitory computer readable storage medium includes, for example, a magnetic or optical disk storage device, solid state storage devices such as Flash memory, a cache, random access memory (RAM) or other non-volatile memory device or devices, and the like. The executable instructions stored on the non-transitory computer readable storage medium are in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, at a secure region of a memory of a processing unit, the secure region physically separate from other regions of the memory, first boot code from an external boot source connected to the processing unit via a peripheral interface;
validating the first boot code at the secure region of the memory; and
transferring the first boot code to a boot memory connected to the processing unit in response to validating the first boot code.

2. The method of claim 1, further comprising:
receiving, at the secure region of the memory, second boot code from the external boot source in response to transferring the first boot code to the boot memory;
validating the second boot code at the secure region of the memory; and
transferring the second boot code to the boot memory in response to validating the second boot code,
wherein the first boot code comprises a first batch of a plurality of batches of boot code and the second boot code comprises a second batch of the plurality of batches of boot code.

3. The method of claim 2, further comprising:
verifying a signature of the plurality of batches of boot code in response to transferring the plurality of batches of boot code to the boot memory; and
accessing the plurality of batches of boot code at the boot memory to bootload the processing unit in response to verifying the signature of the plurality of batches of boot code.

4. The method of claim 1, further comprising:
enabling a bus interface to access the secure region of the memory in response to a request from the external boot source to write boot code to the boot memory, wherein
receiving the first boot code comprises receiving the first boot code via the bus interface.

5. The method of claim 4, further comprising:
initializing a controller of the processing unit to enable communication between the secure region and the external boot source in response to enabling the bus interface.

6. The method of claim 1, wherein the memory comprises a static random access memory.

7. The method of claim 1, further comprising:
restricting transfer of the first boot code to the boot memory in response to failing to validate the first boot code.

8. A method, comprising:
isolating a first boot code received via a peripheral interface at a secure region of memory physically separate from other regions of memory of a processing system; and
transferring the first boot code to a boot memory of the processing system in response to validating a checksum of the first boot code.

9. The method of claim 8, further comprising:
isolating second boot code received via the peripheral interface at the secure region of the memory in response to transferring the first boot code to the boot memory; and
transferring the second boot code to the boot memory in response to validating a checksum of the second boot code,
wherein the first boot code comprises a first batch of a plurality of batches of boot code and the second boot code comprises a second batch of the plurality of batches of boot code.

10. The method of claim 9, further comprising:
verifying a signature of the plurality of batches of boot code in response to transferring the plurality of batches of boot code to the boot memory; and
accessing the plurality of batches of boot code from the boot memory to bootload the processing system in response to verifying the signature of the plurality of batches of boot code.

11. The method of claim 8, further comprising:
enabling a bus interface to access the secure region in response to a request from an external boot source to write boot code to the boot memory; and
receiving the first boot code at the secure region via the bus interface.

12. The method of claim 11, further comprising:
initializing a peripheral interface controller of the processing system to enable communication between the secure region and the external boot source in response to enabling the bus interface.

13. The method of claim 8, wherein the memory comprises a static random access memory.

14. The method of claim 8, further comprising:
restricting transfer of the first boot code to the boot memory in response to failing to validate the checksum of the first boot code.

15. A processing unit to access boot code from an external boot source to bootstrap the processing unit, the processing unit comprising:
a secure region of memory, the secure region physically separate from other regions of memory, wherein the secure region is configured to receive first boot code from the external boot source via a peripheral interface; and
a validation module to validate a checksum of the first boot code, wherein the processing unit is to transfer the first boot code from the secure region of memory to a boot memory of the processing unit in response to the validation module validating the checksum.

16. The processing unit of claim 15, wherein:
the secure region is further configured to receive second boot code from the external boot source via the peripheral interface in response to the processing unit transferring the first boot code to the boot memory; and
the processing unit is to transfer the second boot code to the boot memory in response to validating a checksum of the second boot code,
wherein the first boot code comprises a first batch of a plurality of batches of boot code and the second boot code comprises a second batch of the plurality of batches of boot code.

17. The processing unit of claim 15, wherein:
the validation module is further to verify a signature of the first boot code in response to transferring the first boot code to the boot memory; and
the processing unit is to access the first boot code from the boot memory to bootload the processing unit in response to the validation module verifying the signature of the first boot code.

18. The processing unit of claim 15, further comprising at least one bus interface for accessing the secure region in response to a request from the external boot source to write boot code to the boot memory; and wherein the secure region is configured to receive the first boot code via the at least one bus interface.

19. The processing unit of claim 18, further comprising:
a peripheral interface controller to enable communication between the secure region and the external boot source in response to enabling the at least one bus interface.

20. The processing unit of claim 15, wherein the memory comprises a static random access memory.
